(19) United States
(12) Patent Application Publication
(10) Pub. No.: US 2025/0323393 A1
(43) Pub. Date: Oct. 16, 2025

(54) WELD PLATE FOR BATTERY CELL CURRENT COLLECTOR

(71) Applicant: GM Global Technology Operations LLC, Detroit, MI (US)

(72) Inventors: Hwanchul Kim, Dryden, MI (US); Subrahmanyam Goriparti, Troy, MI (US); Vincent Edward Herrman, Clawson, MI (US); Matthew Arthur Celentano, Berkley, MI (US); Joseph Slabbert, Rochester Hills, MI (US); John Christian Kalil, Washington, MI (US); Reza Kavian, Sterling Heights, MI (US); Masoud Mohammadpour, Novi, MI (US); Seung-Woo Chu, Sterling Heights, MI (US)

(21) Appl. No.: 18/632,767

(22) Filed: Apr. 11, 2024

(51) Int. Cl. H01M 50/536; H01M 50/147

(52) U.S. Cl. CPC H01M 50/536; H01M 50/147

(57) ABSTRACT

A system for electrically connecting tabs of a battery cell includes an electrically conductive weld plate configured to be disposed within a housing of the battery cell and electrically connected to a tab stack formed from a plurality of tabs extending from electrode layers of a cell stack. The weld plate has a first welding surface and a deformable portion that defines a second welding surface, and the deformable portion is configured to be deformed and maintained in a deformed state during welding of the tab stack to the weld plate.

### INTRODUCTION

The subject disclosure relates to batteries, and more particularly to manufacture and assembly of battery cells.

Battery cells are used in various applications, such as automotive applications (e.g., in electric and hybrid vehicles). For example, electric and hybrid vehicle battery systems include battery modules having multiple battery cells. Battery cells may be prismatic-type cells or other types of cells, and typically include multiple layers of both anode material and cathode material. Anode layers are electrically connected by welding a stack of anode tabs, and cathode layers are electrically connected by welding a stack of cathode tabs.

### SUMMARY

In one exemplary embodiment, a system for electrically connecting tabs of a battery cell includes an electrically conductive weld plate configured to be disposed within a housing of the battery cell and electrically connected to a tab stack formed from a plurality of tabs extending from electrode layers of a cell stack. The weld plate has a first welding surface and a deformable portion that defines a second welding surface, and the deformable portion is configured to be deformed and maintained in a deformed state during welding of the tab stack to the weld plate.

In addition to one or more of the features described herein, the system further includes a welding device configured to weld the tab stack to the first welding surface and the second welding surface to form at least part of a connector.

In addition to one or more of the features described herein, the first welding surface is defined by a first arm, the second welding surface faces the first welding surface and is defined by a second arm, and the second arm is configured to be deformed by moving the second arm toward the first arm.

In addition to one or more of the features described herein, the weld plate includes a clip attached to an interior surface of a cap plate assembly, the clip having a first member attached to the interior surface and a moveable member connected to the first member.

In addition to one or more of the features described herein, the clip has an open state configured to allow a tab stack to be inserted into the clip, and a closed state in which the moveable member is positioned relative to the first member so that the first welding surface and the second welding surface contact the tab stack.

In addition to one or more of the features described herein, the moveable member is connected to the first member at a pivot point.

In addition to one or more of the features described herein, the clip has an open state configured to allow a tab stack to be inserted into the clip, and a closed state achieved by folding the clip, wherein the clip is folded by rotating the moveable member about the pivot point.

In addition to one or more of the features described herein, the first welding surface and the second welding surface are planar surfaces, and are configured to maintain the tab stack in a planar configuration and in an undeformed condition during welding.

In another exemplary embodiment, a method of electrically connecting tabs of a battery cell includes acquiring a cell stack, the cell stack configured to be disposed in a housing to form the battery cell, wherein a plurality of tabs extend from electrode layers of the cell stack, forming a tab stack from a portion of the plurality of tabs, and disposing the tab stack against a first welding surface of a weld plate, the weld plate having a deformable portion that defines a second welding surface. The method also includes deforming the deformable portion to bring the second welding surface in contact with the tab stack, and welding the tab stack to the first welding surface and the second welding surface by a welding device to form at least part of a connector, where the tab stack is welded while the deformable portion is maintained in a deformed state.

In addition to one or more of the features described herein, the tab stack is welded while maintaining the tab stack in a planar configuration and in an undeformed condition, wherein the undeformed condition is a condition in which the tab stack is not folded prior to welding, and is not subject to bending forces during the welding.

In addition to one or more of the features described herein, the first welding surface is defined by a first arm, and the second welding surface faces the first welding surface and is defined by a second arm.

In addition to one or more of the features described herein, disposing the tab stack includes inserting the tab stack into a slot defined by the first arm and the second arm, and deforming the second arm to move the second welding surface toward the first arm and into contact with the tab stack.

In addition to one or more of the features described herein, the weld plate includes a clip attached to an interior surface of a cap plate assembly, the clip having a first member attached to the interior surface and a moveable member connected to the first member.

In addition to one or more of the features described herein, disposing the tab stack includes inserting the tab stack into the clip when the clip is in an open state, and moving the moveable member toward the first member so that the first welding surface and the second welding surface contact the tab stack.

In addition to one or more of the features described herein, the moveable member is connected to the first member at a pivot point, and disposing the tab stack includes inserting the tab stack into the clip when the clip is in an open state, and folding the clip by rotating the moveable member about the pivot point.

In yet another exemplary embodiment, a computer program product includes a computer-readable memory that has computer-executable instructions stored thereupon, the computer-executable instructions when executed by a processor cause the processor to perform operations. The operations include acquiring a cell stack, the cell stack configured to be disposed in a housing to form a battery cell, where a plurality of tabs extend from electrode layers of the cell stack. The operations also include forming a tab stack from a portion of the plurality of tabs, and disposing the tab stack against a first welding surface of a weld plate, the weld plate having a deformable portion that defines a second welding surface, deforming the deformable portion to bring the second welding surface in contact with the tab stack, and welding the tab stack to the first welding surface and the second welding surface by a welding device to form at least part of a connector, where the tab stack is welded while the deformable portion is maintained in a deformed state.

In addition to one or more of the features described herein, the first welding surface is defined by a first arm, and the second welding surface faces the first welding surface and is defined by a second arm.

In addition to one or more of the features described herein, disposing the tab stack includes inserting the tab stack into a slot defined by the first arm and the second arm, and deforming the second arm to move the second welding surface toward the first arm and into contact with the tab stack.

In addition to one or more of the features described herein, the weld plate includes a clip attached to an interior surface of a cap plate assembly, the clip having a first member attached to the interior surface and a moveable member connected to the first member.

In addition to one or more of the features described herein, disposing the tab stack includes inserting the tab stack into the clip when the clip is in an open state, and moving the moveable member toward the first member so that the first welding surface and the second welding surface contact the tab stack.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a battery cell, in accordance with an exemplary embodiment;

FIG. 2 depicts a battery cell, in accordance with an exemplary embodiment;

FIG. 3 depicts a system for manufacturing a battery cell, in accordance with an exemplary embodiment;

FIG. 4 depicts a weld plate for use in electrically connecting components of a battery cell, in accordance with an exemplary embodiment;

FIG. 5 depicts a tab connection assembly including the weld plate of FIG. 4, in accordance with an exemplary embodiment;

FIG. 6 depicts the tab connection assembly of FIG. 5 during a welding process used to connect a battery cell to the tab connection assembly;

FIG. 7 depicts the tab connection assembly of FIG. 5 during a welding process used to connect a battery cell to the tab connection assembly;

FIG. 8 depicts a tab connection assembly including a weld plate having clips for connecting a battery cell to the tab connection assembly, in accordance with an exemplary embodiment;

FIG. 9 depicts the tab connection assembly and weld plate of FIG. 8;

FIGS. 10A-10D depicts a clip of FIG. 8, and aspects of a method of electrically connecting battery cell tabs and manufacturing a battery cell, in accordance with an exemplary embodiment;

FIG. 11 depicts a tab connection assembly including a weld plate having clips for connecting a battery cell to the tab connection assembly, in accordance with an exemplary embodiment; and

FIG. 12 depicts the tab connection assembly and weld plate of FIG. 8.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for facilitating attachment and electrical connection of electrodes (anodes and cathodes) in a battery cell. An embodiment of a system for consolidating and joining portions of electrodes or electrode layers includes a connection assembly configured to perform functions related to forming battery tab stacks, welding tab stacks and forming connectors for a battery cell.

An embodiment of the connection assembly includes an internal terminal weld plate (also referred to as an internal weld plate) configured to be attached to, and electrically connected to, a tab stack or tab stacks. The weld plate includes at least one portion that is deformable, such that the portion can be deformed and maintained in a deformed state during welding.

In an embodiment, the weld plate defines a pair of welding surfaces used to weld a tab stack to the weld plate. The pair of welding surfaces are brought together to contact a tab stack (and optionally compress the tab stack) during welding. The welding surfaces may be configured as planar surfaces, or are otherwise configured so that the tab stack is in a planar form. The tab stack is in a “planar form” when the tab stack (or at least a portion of the tab stack subject to welding) is vertically, horizontally or otherwise linearly oriented. The tab stack can thus be welded or joined without folding any portion of the tab stack (e.g., any portion subject to the weld), and without deformation due to bending forces.

The internal weld plate may have any of various configurations. For example, the weld plate includes one or more welding sections, where each welding section includes opposing arms defining opposing surfaces. At least one of the arms is deformed (e.g., by a clamp) after a tab stack is inserted in the section, to bring the opposing surfaces in contact with the tab stack. In another example, the weld plate includes one or more clips that can be opened (or be in an initial open position) for insertion of a tab stack and closed to contact the tab stack for subsequent compression and/or welding through the tab stack and clip.

Embodiments described herein present numerous advantages and technical effects. The embodiments provide for an improved manufacturing process that facilitates proper attachment and electrical connection of electrode tabs. For example, embodiments provide an advanced terminal block that enhances the durability of terminals following the welding process. The embodiments allow for welding or joining tab stacks and constructing terminals without the need for pre-welding (e.g., ultrasonic welding).

Embodiments of the advanced terminal block feature a U-shaped design that minimizes empty space to the extent required by the thickness of the cell tab. The embodiments also allow for using the butterfly welding method in prismatic can cells. Through the implementation of this welding technique, the embodiments enhance the robustness of the welded connection between tabs and a terminal block.

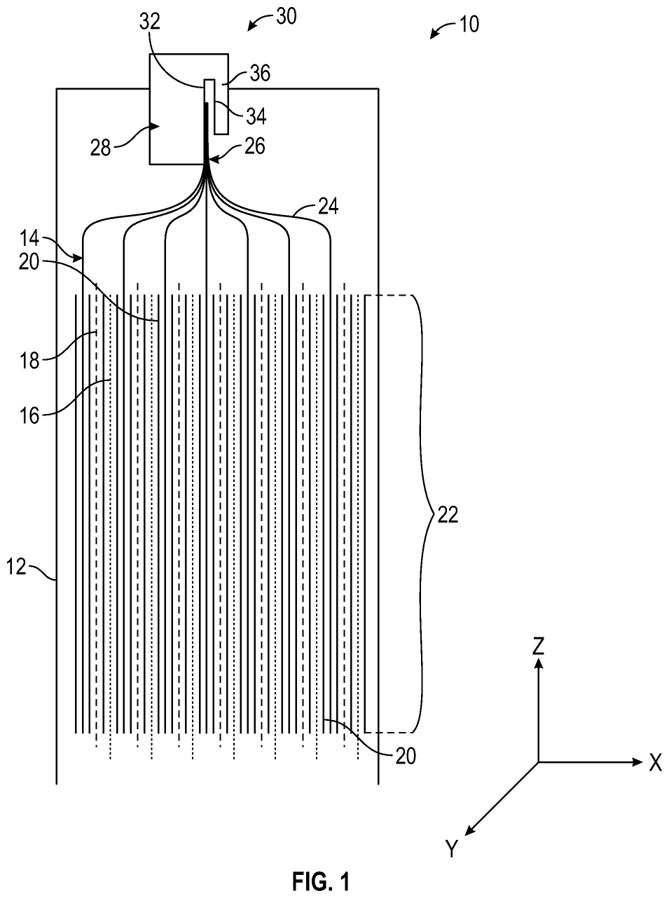

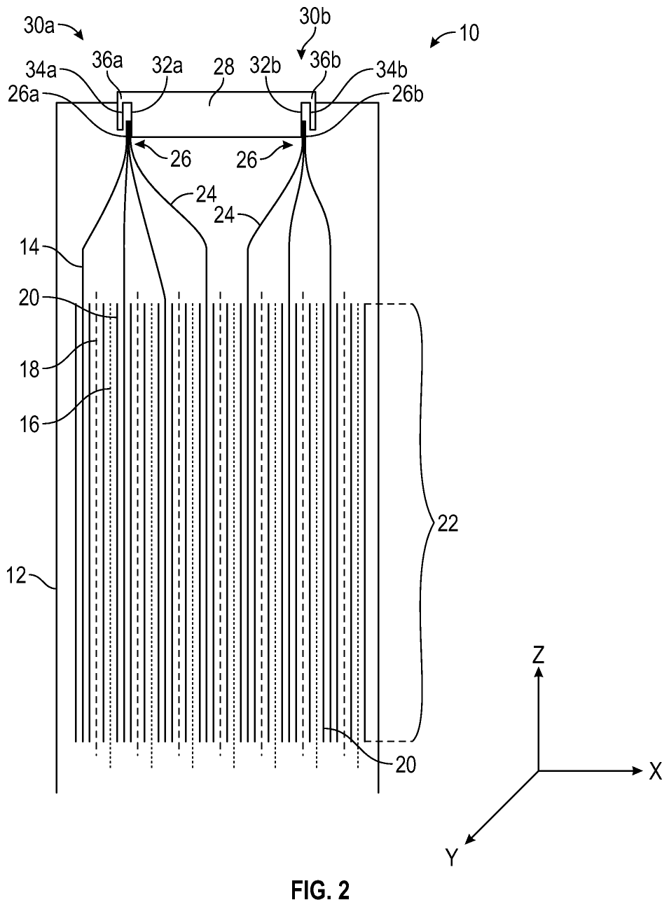

FIGS. 1 and 2 depict examples of a battery cell 10. The battery cell includes a housing 12, which may be a rigid housing designed for a prismatic cell. For example, the housing is a rectangular housing or “can” made from aluminum or other material. Embodiments described herein are not limited to any particular type of battery cell, or any particular shape, size or material of the electrodes and the housing. For example, embodiments may be applicable cells having various types of housings.

The battery cell 10 includes a plurality of layers that form negative electrodes or anodes, and positive electrodes or cathodes. The anodes are made from electrically conductive anode layers 14, and the cathodes are made from electrically conductive cathode layers 16. The anode layers 14 and the cathode layers 16 are configured as thin sheets or foils. A separator 18 made from an electrically insulating material (e.g., polymer or ceramic) is disposed between each anode layer 14 and adjacent cathode layer 16. An active material 20, such as a graphite or a material including Lithium, is disposed in the housing 12 between the various layers. These internal layers constitute a battery cell stack 22.

It is noted that the number of electrodes is not limited to the number shown in FIG. 1. The battery cell 10 may have any number of anode layers 14 and any number of cathode layers 16. For example, the battery cell 10 may have hundreds of individual foil layers forming the electrode layers.

As shown in FIG. 1, each anode layer 14 includes a portion 24 that extends away from the interior of the cell 10 and allows for electrical connection of each anode layer 14 with another anode layer 14. This portion 24 is also referred to as a tab 24 or connection tab 24. Although not shown, the cathode layers 16 include tabs so that the cathode layers 16 can be connected. The cathode layer tabs (not shown) may extend from an end opposite to the anode tabs 24 (in the z-direction) or extend from the same end.

Portions of the tabs 24 (or a subset thereof) are stacked together as at least one tab stack 26. The portions making up each tab stack 26 are welded together by, for example, a laser weld. The cell 10 is not so limited, as other techniques may be used, such as ultrasonic and other metal-to-metal joining procedures. In an embodiment, the tab stacks are welded using a laser welding technique (which can be effectively achieved without ultrasonic pre-welding).

Each tab stack 26 is welded to an electrically conductive component 28 (“weld plate”) that provides a contact point for welding the tab stack 26 together and may serve as at least part of a connector. The connector forms a negative terminal. The cathode layers 16 may be similarly welded to a positive terminal (not shown) that extends to an exterior of the housing 12. The weld plate 28 may form the connector, either exclusively or in combination with other conductive bodies.

In an embodiment, the weld plate 28 includes at least one welding section 30. The welding section 30 defines a pair of surfaces (“welding surfaces”) that provide welding contacts where the tab stack 26 is fused to the weld plate 28.

For example, the welding section 30 includes a first welding surface 32 and a second welding surface 34. A portion 36 of the weld plate that includes the second welding surface 34 is deformable, such that the second welding surface 34 can be moved generally toward the first welding surface 32. In this way, the surfaces 32 and 34 can be brought together in contact with the tab stack 26 during welding to ensure proper contact and fusion of the tab stack 26 with the surfaces 32 and 34. It is noted that the deformable portion 36 may be an integral part of the weld plate 28 (i.e., as a single piece), or attached to the remainder of the weld plate 28.

In an embodiment, the surfaces 32 and 34 are configured to provide a base that allows the tab stack 26 to be welded without folding, deflecting or otherwise applying bending forces (as opposed to tensile forces, which may be applied during welding) to the portions making up the tab stack (i.e., the portions that are fused to one another and the weld plate 28). In an embodiment, each welding surface 32 and 34 is a generally planar surface.

FIG. 1 shows an example in which the tabs 24 are gathered and joined as a single tab stack 26 for the anode layers 14 (a single tab stack for connection of the cathode layers may be similarly formed).

FIG. 2 shows an example in which the tabs 24 are gathered into two separate tab stacks 26 (denoted as tab stacks 26a and 26b) that are each welded to a respective welding section 30 (denoted as sections 30a and 30b). Welding section 30a includes opposing welding surfaces 32a and 34a, and welding section 30b includes opposing welding surfaces 32b and 34b.

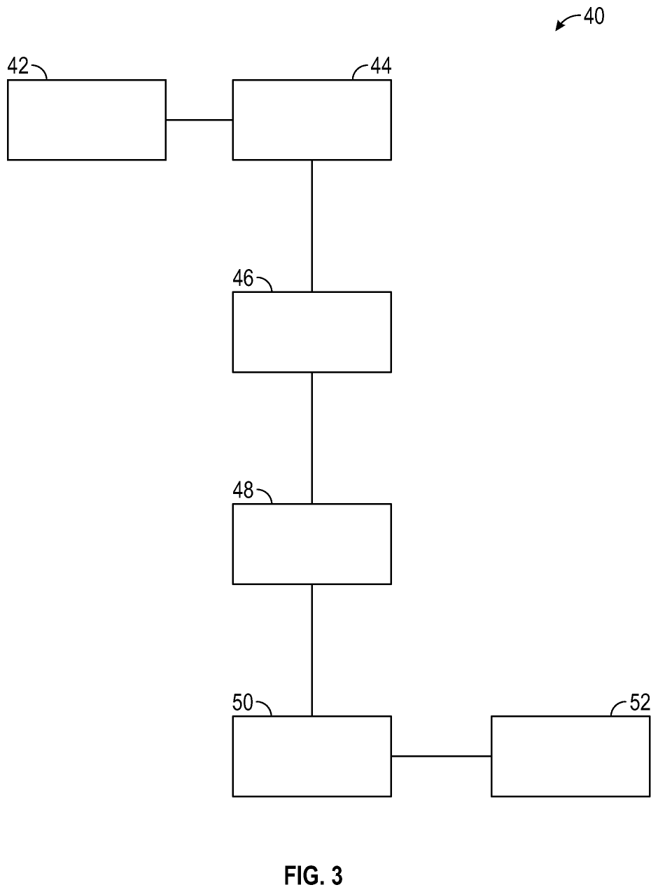

FIG. 3 depicts an example of a manufacturing system 40 for manufacturing battery cells. The manufacturing system 40 includes various manufacturing stations, which may be controlled or operated by a computer system, a human operator or a combination thereof. As described herein, a “station” refers to any number, combination and layout of equipment and is not intended to limit the manufacturing system 40 to any specific machine or combination of machines.

The manufacturing system 40 includes, for example, an active material processing station 42 for preparing active materials to be applied to electrode layers. The system 40 may also include a coating station 44 for coating electrodes with the active materials. The manufacturing system 40 also includes an electrode cutting station 46, which can be used to form electrode layers and tabs from sheets of electrode material (e.g., copper and aluminum sheets).

The system 40 also includes a stacking station 48 for forming the various layers of a battery stack, and a welding station 50 for welding electrode layer tabs. The welding station 50 may include the weld plate 28 as described herein, in combination with welding equipment.

The system 40 may include, or be connected to, one or more processing devices for performing various aspects of manufacturing. For example, the welding station 50 is connected to a controller 52 for control of processes such as bonding, trimming and/or welding.

The system 40 may include other stations for performing subsequent processes to complete battery cells. Examples include an assembly station (e.g., for cell package or housing construction, sealing, electrolyte filling, etc.), and stations for manufacturing battery assembles, such as battery packs and/or modules.

For example, battery cells can be installed in a battery assembly. The battery assembly may be a battery module having a plurality of electrically connected battery cells, such as a battery module that is incorporated into a vehicle (e.g., an electric or hybrid vehicle) as part of a battery pack.

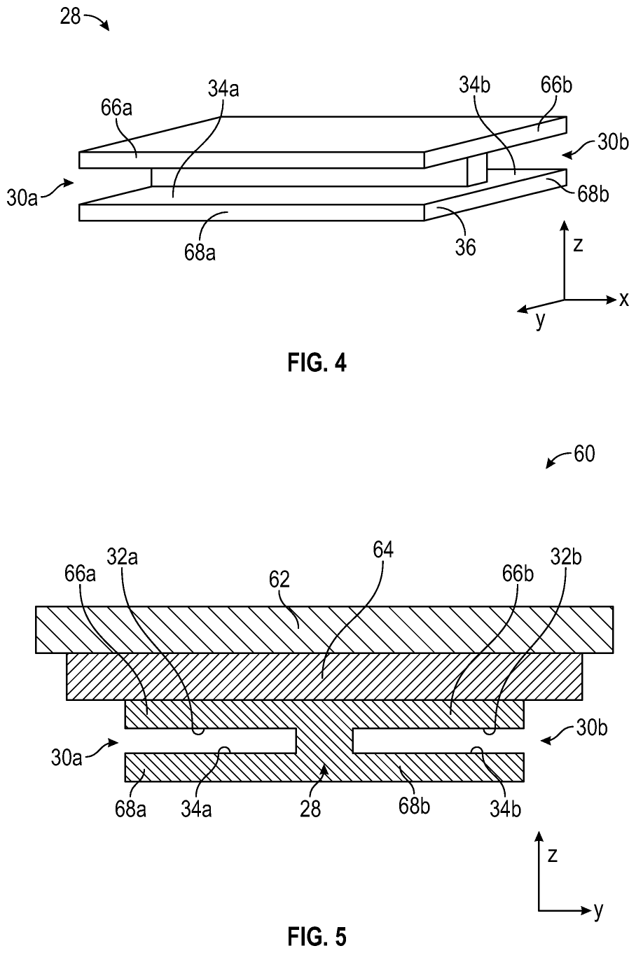

FIG. 4 is a perspective view of an embodiment of the weld plate 28, shown in an x, y, z coordinate system. FIG. 5 is a cross-sectional view a tab connection assembly 60 including the weld plate (along a y-z plane). Although the weld plate 28 is shown as having two weld sections, embodiments are not so limited, as the weld plate 28 may have a single weld section.

As shown in FIG. 4, the weld plate 28 is an integral body forming opposing welding sections 30a and 30b. Each welding section 30a and 30b has a deformable portion 36 in the form of an arm or connection member that can be moved toward an opposing arm or member.

FIG. 5 depicts an embodiment of the tab connection assembly 60, which includes the weld plate 28. In this embodiment, the weld plate 28 is an internal terminal weld plate 28 configured to be disposed within a housing (e.g., the prismatic housing 12 of FIGS. 1 and 2). The tab connection assembly 60 includes a connector formed from a conductive material (and configured to provide an electrical connection between the anode layers and a device to be powered).

For example, the tab connection assembly 60 includes a cap plate 62, which is fixedly disposed relative to the weld plate 28. The cap plate 62 may form a part of a cover of a battery assembly, and can be attached directly to the weld plate 28, or via an isolation insert 64. Other components (e.g., feedthroughs, terminals, etc.) may also be coupled with the weld plate 28 to form the connection assembly 60. All of the components of the connection assembly 60 are moveable as a unit.

Each welding section 30a, 30b includes a pair of arms that define opposing welding surfaces. At least one of the arms is deformable, such that an arm can be deformed to bring the welding surfaces closer together and contact a tab stack inserted therein. In addition, the arms can be brought together to compress the tab stack.

For example, as shown in FIGS. 4 and 5, the welding section 30a includes a first surface 32a defined by a first arm 66a and a second surface 34a defined by a second arm 68a. The welding section 30b includes a first surface 32b defined by a first arm 66b and a second surface 34b defined by a second arm 68b. One or more of the arms (or all of the arms) may have rounded edges or be otherwise configured so that there are no sharp edges that could cause tearing.

The various methods are described herein for forming anode tabs and welding an anode tab stack or stacks to an anode weld plate. It is understood that the methods are similarly applicable to cathode tabs.

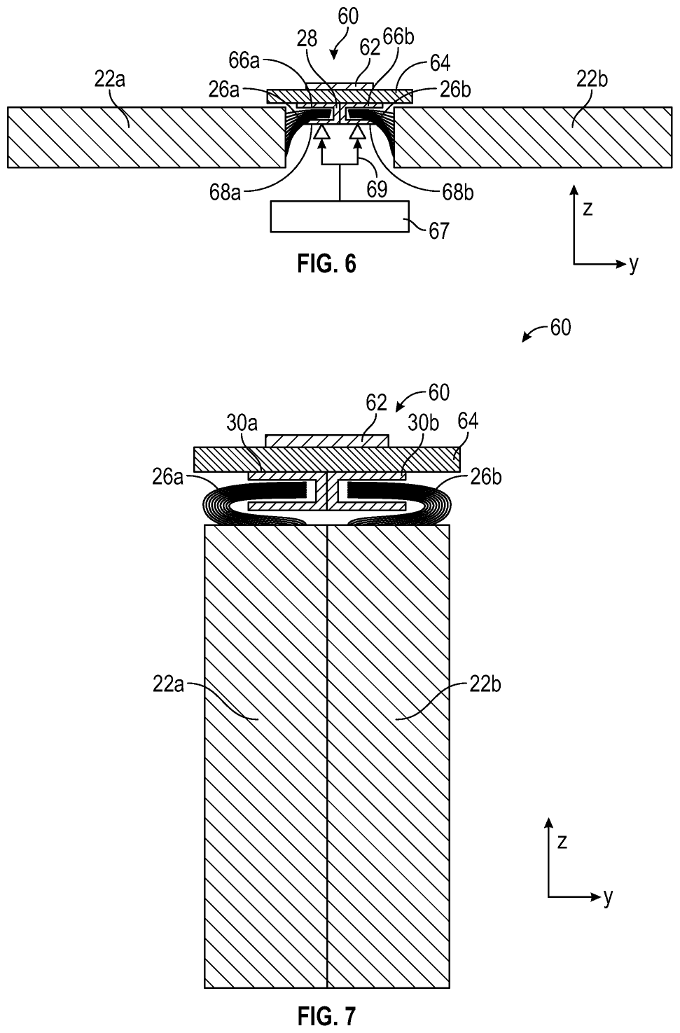

FIGS. 6 and 7 illustrates aspects of a method of manufacturing a battery cell using the tab connection assembly 60 of FIG. 5. The method (or parts thereof) may be performed by any suitable processing device or devices, such as one or more controllers of the manufacturing system 40 (e.g., the controller 52 connected to the welding station 50), but is not so limited.

The method includes a number of steps or stages. The method is not limited to the number or order of steps therein, as some steps may be performed in a different order than that described below, or fewer than all of the steps may be performed.

At a first stage, electrodes are created or acquired, which include anode sheets and cathode sheets made from a coated conductive material. For example, the anode sheets are made from copper, and the cathode sheets are made from aluminum.

Anode and cathode sheets are coated, cut, trimmed and/or otherwise processed to create anode and cathode layers, and the anode layers and cathode layers are assembled with other layers (e.g., separator layers) to form the cell stack 22. Each anode and cathode layer has a respective tab extending from the cell stack.

The anode tabs 24 are partitioned into two sets of tabs 24a and 24b (See FIG. 2) forming tab stacks 26a and 26b. In addition, the cell stack is portioned into two cell stack portions 22a and 22b, allowing use of the so-called butterfly method, which is discussed further herein.

As shown in FIG. 6, the tab stack 26a is inserted into a slot formed by the arms 66a and 68a, and the tab stack 24b is inserted into a slot formed by the arms 66b and 68b. Optionally, a clamp or other device may be used to apply a force to the arms 68a and 68b to bond the tab stacks 26a and 26b, and to facilitate forming a weld. In the butterfly method, the cell stacks 22a and 22b are laid on opposite sides of the weld plate 28.

A laser welding device 67 (or other welding device) is used to apply one or more laser beams 69 to fuse the sets of tabs (tab stacks) to the weld plate 28. For example, the laser welding device 67 is used to simultaneously fuse the tab stack 26a to both of the first arm 66a and the second arm 68, and fuse the tab stack 26b to the first arm 66b and the second arm 68b.

Referring to FIG. 7, after the welds are complete, the cell stack portions 22a and 22b may be brought together or otherwise configured for packaging in a housing. For example, the tab stacks 26a and 26b are folded about 90 degrees, and the cell stack portions 22a and 22b are rotated, brought together and adhered or otherwise attached to form a consolidated cell stack 22.

Additional steps or stages may be performed to complete assembly of the battery cell 10, such as installing the welded electrodes in a housing (e.g., pouch or rigid housing) with separator layers, quality inspection, electrolyte filling, housing sealing and others.

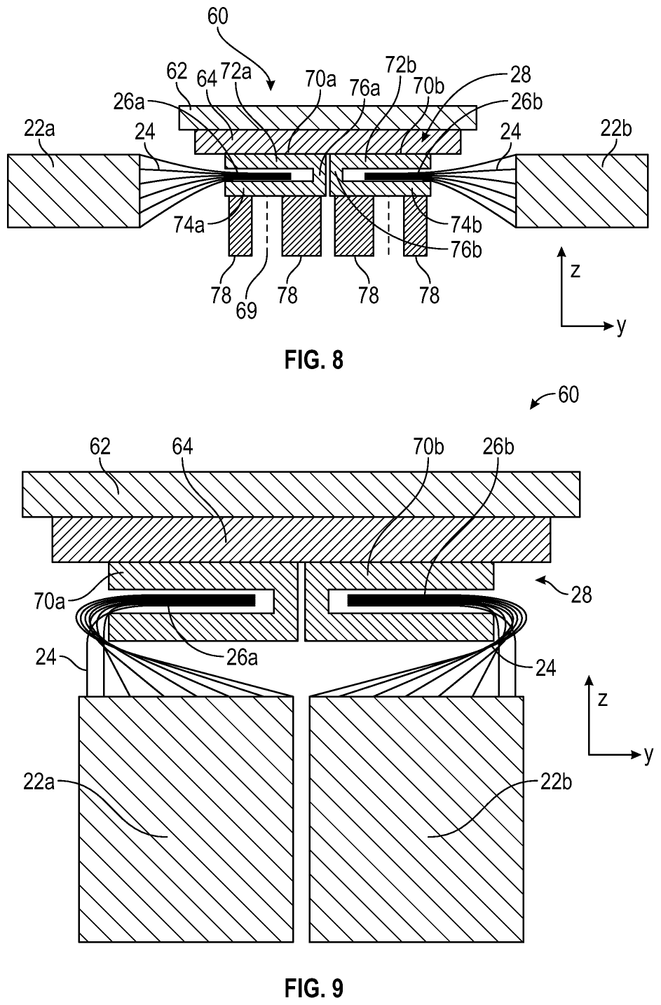

In an embodiment, the weld plate 28 includes one or more separate structures (referred to herein as “clips”) that define a slot or receptacle for a tab stack. FIGS. 8, 9 and 10A-10D depict an embodiment of the weld plate 28, which includes at least one clip 70 (denoted as clips 70a and 70b in FIGS. 8 and 9). The clip may be integral with the connection assembly 60, or welded or otherwise attached to components of the connection assembly 60. In addition, the clip 70 may be a single clip or multiple clips.

Referring to FIGS. 8 and 9, the clip 70 includes a first clip 70a having a first member 72a that is attached to or integral with the connection assembly 60. The clip 70a also includes a second member 74a that is connected to the first member 72a, such that the second member 74a is moveable relative to the first member 72a. For example, the second member 74a is connected to the first member 72a by a pivot point 76a, that allows the clip 70a to be opened and closed by rotating the second member 74a.

Likewise, the weld plate 28 includes a second clip 70b having a first member 72b that is attached to or integral with the cap assembly 60, and a second member 74b that is moveable relative to the first member 72b by a pivot point 76b. The clip 70b can be opened and closed by rotating the second member 74b about the pivot point 76b.

The pivot point (i.e., the pivot point 76a and/or 76b) may take any suitable form. For example, a relatively thin or bendable section can form the pivot point, or a pin, hinge or other mechanism is provided to allow rotation.

FIG. 8 shows the clips 70a and 70b in a closed state, in which each clip 70a and 70b defines a respective slot for inserting a tab stack. In this state, the arms of each clip 70a and 70b can be compressed by a clamp 78 to ensure good contact and/or bonding. Subsequent to welding (e.g., using laser beams 69), the cell stack portions 22a and 22b are rotated and brought together as shown in FIG. 9.

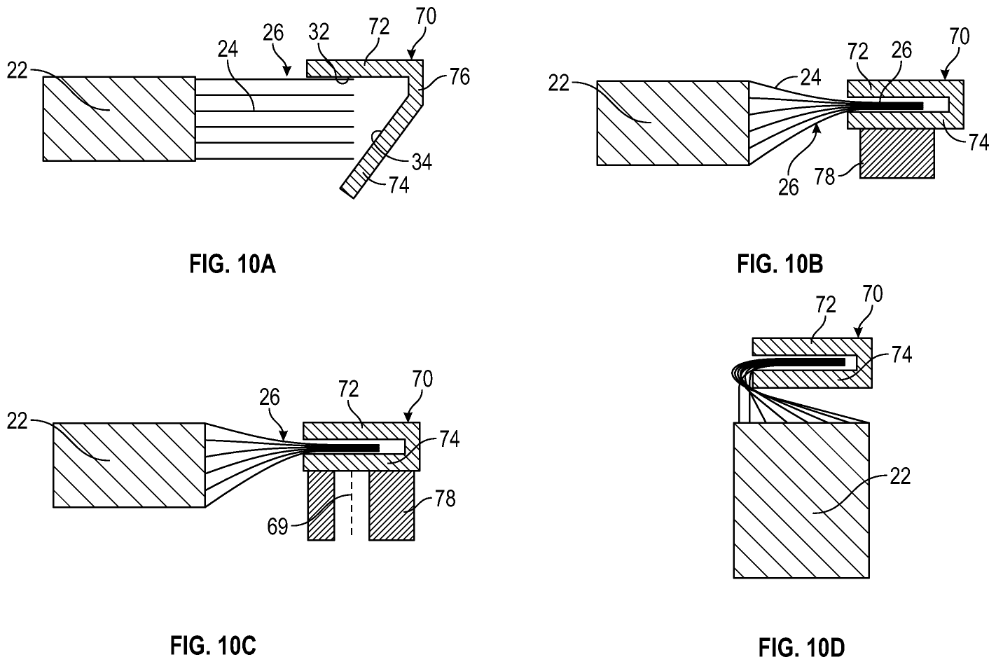

FIGS. 10A-10D illustrates aspects of a method of manufacturing a battery cell. The method (or parts thereof) may be performed by any suitable processing device or devices, such as one or more controllers of the manufacturing system 40 (e.g., the controller 52) and/or the connection system 60, but is not so limited.

The method includes a number of steps or stages. The method is not limited to the number or order of steps therein, as some steps may be performed in a different order than that described below, or fewer than all of the steps may be performed.

At a first stage, electrodes are created or acquired, and processed to form the cell stack 22 connected to anode tabs 24 and cathode tabs. The anode tabs may be partitioned into two sets of tabs (e.g., tab stacks 24a and 24b).

At a second stage, referring to FIG. 10A, anode tabs 24 are assembled as a tab stack 26 and inserted into a clip 70 (e.g., one of the clips 70a, 70b). As shown, the clip 70 is in an open state, in which the first member 72 and the second member 74 define a relatively wide opening.

The clip 70 may be configured so that the clip 70 is in a default open state. Alternatively, the clip 70 can be in a default closed state, and opened up to put the clip 70 into the open state.

At a third stage, referring to FIG. 10B, the clip 70 is closed by moving the second member 74 closer to the first member 72. A clamp 78 may be applied to compress the tab stack 26 and ensure good contact.

At a fourth stage, referring to FIG. 10C, as the clamp 78 applies pressure, a laser beam 69 is applied to the clip 70 and the tab stack 26. The laser beam 69 forms a weld through the tab stack 26 and portions of the first and second members 72 and 74, thereby fusing the tab stack 26 to the clip 70.

At a fifth stage, referring to FIG. 10D, the stack 22 is rotated using the butterfly method. Additional steps or stages may be performed to complete assembly of the battery cell 10, such as installing the welded electrodes in a housing (e.g., pouch or rigid housing) with separator layers, quality inspection, electrolyte filling, housing sealing and others.

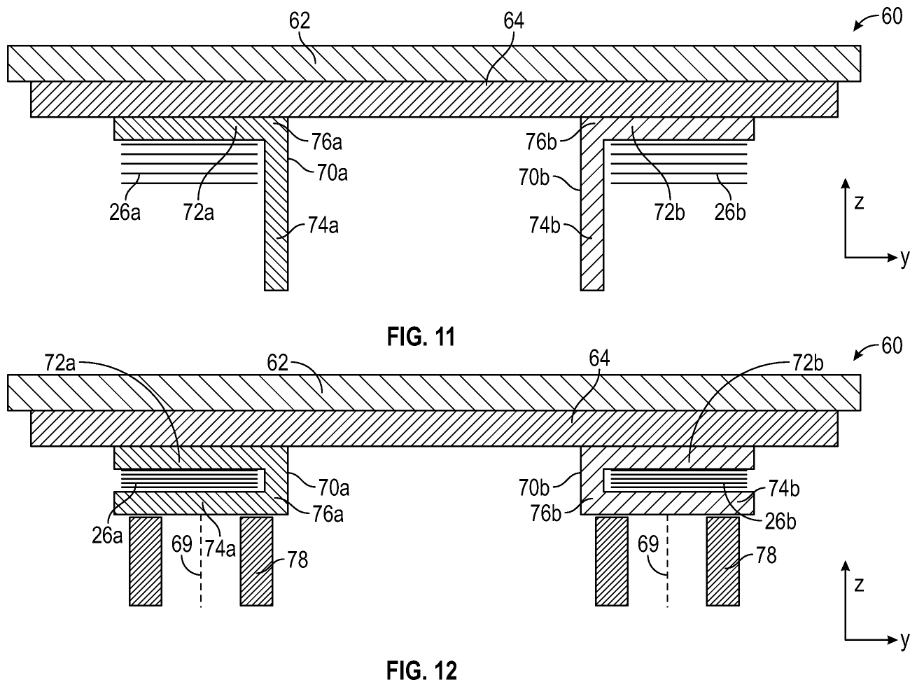

FIGS. 11 and 12 depict an embodiment of the connection assembly 60, in which the clip 70 (clips 70a and 70b) is a generally L-shaped clip. For example, as shown in FIG. 11, the clip 70a includes the first member 72a and the second member 74a in an open position. Similarly, the clip 70b includes the first member 72b and the second member 74b in an open position.

In the open position, the second member 74a is perpendicular (or at least partially perpendicular) to the first member 72a. It is noted that, in the open position, the second member 74a can be less than perpendicular (e.g., forming an angle less than 90 degrees, such as 45 degrees or 60 degrees).

FIG. 11 shows the clips 70a and 70b in the open position. Also shown are the sets of tabs 26a and 26b as inserted into the clips 70a and 70b.

As shown in FIG. 12, after the sets of tabs are inserted, the clips are closed, forming a U-shape that encloses the respective tab stacks 26a and 26b. Subsequently, the clips and tab stacks are compressed using the clamping devices 78, and welded using lasers 69 to fuse the tabs to the clips.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for electrically connecting tabs of a battery cell, comprising:
an electrically conductive weld plate configured to be disposed within a housing of the battery cell and electrically connected to a tab stack formed from a plurality of tabs extending from electrode layers of a cell stack, the weld plate having a first welding surface and a deformable portion that defines a second welding surface, wherein the deformable portion is configured to be deformed and maintained in a deformed state during welding of the tab stack to the weld plate.

2. The system of claim 1, further comprising a welding device configured to weld the tab stack to the first welding surface and the second welding surface to form at least part of a connector.

3. The system of claim 1, wherein the first welding surface is defined by a first arm, the second welding surface faces the first welding surface and is defined by a second arm, and the second arm is configured to be deformed by moving the second arm toward the first arm.

4. The system of claim 1, wherein the weld plate includes a clip attached to an interior surface of a cap plate assembly, the clip having a first member attached to the interior surface and a moveable member connected to the first member.

5. The system of claim 4, wherein the clip has an open state configured to allow a tab stack to be inserted into the clip, and a closed state in which the moveable member is positioned relative to the first member so that the first welding surface and the second welding surface contact the tab stack.

6. The system of claim 4, wherein the moveable member is connected to the first member at a pivot point.

7. The system of claim 6, wherein the clip has an open state configured to allow a tab stack to be inserted into the clip, and a closed state achieved by folding the clip, wherein the clip is folded by rotating the moveable member about the pivot point.

8. The system of claim 1, wherein the first welding surface and the second welding surface are planar surfaces, and are configured to maintain the tab stack in a planar configuration and in an undeformed condition during welding.

9. A method of electrically connecting tabs of a battery cell, comprising:
acquiring a cell stack, the cell stack configured to be disposed in a housing to form the battery cell, wherein a plurality of tabs extend from electrode layers of the cell stack;
forming a tab stack from a portion of the plurality of tabs, and disposing the tab stack against a first welding surface of a weld plate, the weld plate having a deformable portion that defines a second welding surface; and
deforming the deformable portion to bring the second welding surface in contact with the tab stack, and welding the tab stack to the first welding surface and the second welding surface by a welding device to form at least part of a connector, wherein the tab stack is welded while the deformable portion is maintained in a deformed state.

10. The method of claim 9, wherein the tab stack is welded while maintaining the tab stack in a planar configuration and in an undeformed condition, wherein the undeformed condition is a condition in which the tab stack is not folded prior to welding, and is not subject to bending forces during the welding.

11. The method of claim 9, wherein the first welding surface is defined by a first arm, and the second welding surface faces the first welding surface and is defined by a second arm.

12. The method of claim 11, wherein disposing the tab stack includes inserting the tab stack into a slot defined by the first arm and the second arm, and deforming the second arm to move the second welding surface toward the first arm and into contact with the tab stack.

13. The method of claim 9, wherein the weld plate includes a clip attached to an interior surface of a cap plate assembly, the clip having a first member attached to the interior surface and a moveable member connected to the first member.

14. The method of claim 13, wherein disposing the tab stack includes inserting the tab stack into the clip when the clip is in an open state, and moving the moveable member toward the first member so that the first welding surface and the second welding surface contact the tab stack.

15. The method of claim 13, wherein the moveable member is connected to the first member at a pivot point, and disposing the tab stack includes inserting the tab stack into the clip when the clip is in an open state, and folding the clip by rotating the moveable member about the pivot point.

16. A computer program product comprising a computer-readable memory that has computer-executable instructions stored thereupon, the computer-executable instructions when executed by a processor cause the processor to perform operations comprising:
acquiring a cell stack, the cell stack configured to be disposed in a housing to form a battery cell, wherein a plurality of tabs extend from electrode layers of the cell stack;
forming a tab stack from a portion of the plurality of tabs, and disposing the tab stack against a first welding surface of a weld plate, the weld plate having a deformable portion that defines a second welding surface; and
deforming the deformable portion to bring the second welding surface in contact with the tab stack, and welding the tab stack to the first welding surface and the second welding surface by a welding device to form at least part of a connector, wherein the tab stack is welded while the deformable portion is maintained in a deformed state.

17. The computer program product of claim 16, wherein the first welding surface is defined by a first arm, and the second welding surface faces the first welding surface and is defined by a second arm.

18. The computer program product of claim 17, wherein disposing the tab stack includes inserting the tab stack into a slot defined by the first arm and the second arm, and deforming the second arm to move the second welding surface toward the first arm and into contact with the tab stack.

19. The computer program product of claim 16, wherein the weld plate includes a clip attached to an interior surface of a cap plate assembly, the clip having a first member attached to the interior surface and a moveable member connected to the first member.

20. The computer program product of claim 19, wherein disposing the tab stack includes inserting the tab stack into the clip when the clip is in an open state, and moving the moveable member toward the first member so that the first welding surface and the second welding surface contact the tab stack.
